(19) United States
(12) Patent Application Publication
(10) Pub. No.: US 2008/0115114 A1
(43) Pub. Date: May 15, 2008

(54) AUTOMATED SOFTWARE UNIT TESTING

(76) Inventors: Sashank Palaparthi, Secunderabad (IN); Swarup Vishnuvajjula, Hyderabad (IN)

Correspondence Address: PILLSBURY WINTHROP SHAW PITTMAN, LLP, P.O. BOX 10500, MCLEAN, VA, 22102, US

(21) Appl. No.: 11/558,783

(22) Filed: Nov. 10, 2006

(51) Int. Cl. G06F 9/44

(52) U.S. Cl. 717/128

(57) ABSTRACT

In one embodiment, the invention provides for discovery of the functional aspects of a piece of software code. The invention then generates a set of testing parameters designed to test the piece of software code for proper operation of each of the discovered functions. The discovered functions and their corresponding testing parameters may then be stored as one or more test cases. Test code is then generated for each test case. The test code enables each test case to be run to determine whether the corresponding functions operate properly.

### FIELD OF THE INVENTION

The invention relates to a system and method for automated unit testing of software, including the automatic generation of unit test cases.

### BACKGROUND OF THE INVENTION

Successful software development and implementation requires various levels of software testing. In some instances, software testing involves a developer, tester, or other worker manually analyzing software code and manually generating test cases for each functional aspect of the software to be tested. As referred to herein, a test case refers to the set of parameters necessary for unit testing the proper operation of a functional aspect in a reasonable percentage of possible scenarios. The developer, tester, or other worker must then write test code for each function to “unit test” the software. As used herein, unit testing refers to validating that a particular functional aspect for a particular unit of software operates properly under certain relatively predictable conditions. Because the test cases are designed to test the proper operation of a functional aspect in a reasonable percentage of predictable conditions, there may be scenarios that arise during further testing or post-implementation scenarios wherein the unit of software “regresses” (e.g., fails to perform properly wherein it previously performed properly). In these cases of regression, prior unit testing aids developers or other workers by establishing a threshold or baseline. This baseline indicates that the regression was caused by parameters outside the baseline. This knowledge focuses remedial efforts and additional testing of the software.

However, the development of test cases, test code, the running of unit tests, and the interpretation of unit tests is a time consuming process. In many cases, developers do not have the time or the motivation to properly perform all of these unit testing procedures. In some cases, this type of testing is passed on to testers. However, in some cases, testers are not as technically savvy regarding the software language in which the software code is written, and thus, are not always able to properly perform unit testing. Because of these and other challenges and problems to performing basic unit testing, it often goes undone or is performed incompletely or inadequately.

Thus, to ensure at least a modicum of quality testing for a given unit of software code, while relieving the burden on developers, testers, and other workers, an automated, unit testing open-platform framework that operates across multiple software languages would be advantageous.

### SUMMARY OF THE INVENTION

The invention solving these and other problems in the art relates to a system and method for automated unit testing of software, including the automatic generation of unit test cases. In one embodiment, the invention provides for discovery of the functional aspects of a piece of software code. The invention then generates a set of testing parameters designed to test the piece of software code for proper operation of each of the discovered functions. The discovered functions and their corresponding testing parameters may then be stored as one or more test cases. Test code is then generated for each test case. The test code enables each test case to be run to determine whether the corresponding functions operate properly.

In one embodiment, the invention provides a system for automated unit testing of software. The system may include an automated unit testing application. The system may interact with subject software, may produce test case documents, may report unit testing results, and/or may include other interaction or output.

In one embodiment, the subject software may comprise a portion of software code to be tested. The subject software may comprise source code written in one of any number of available programming languages. In one embodiment, the subject software may be written in an object-oriented programming language such as, for example, Java. Other programming languages may be used. In some embodiments, the subject software may comprise object code (e.g., machine-readable code) and may take the form of, for example, an executable file.

In one embodiment, the subject software may include one or more “functional aspects.” These functional aspects may comprise the general functional purposes that the subject software serves. In some embodiments, each of these functional aspects may be implemented in the subject software by one or more formal components of the software language in which the subject software is written. For example, if the subject software is coded using an object-oriented programming language, the subject software may include one or more classes, functions, methods, or other elements that are used to carry out each of its functional aspects. In some embodiments, some of these functional aspects may have “cross-cutting concerns.” For example, even if the subject software is coded using an object-oriented programming language, the subject software may include one or more functional aspects (like logging/security, etc.) that affect other functional aspects.

In some embodiments, some of these functional aspects may have “corss-cutting concern.” For example, even if the subject software is coded using an object oriented programming language, the subject software is may include one or more functional aspects (e.g., logging, security, or other functional aspects) that affect other functional aspects.

In one embodiment, the system of the invention includes a unit testing application, which may comprise a computer application that is designed to automate the unit testing of the subject software and/or other software code. The unit testing application may comprise and/or utilize one or more software modules for performing automated unit testing. In one embodiment, the one or more software modules may include a parsing module, a unit testing module, a test case document generator, a report generation module, and/or other modules.

In one embodiment, the parsing module may include a software module or other computer readable instructions that examine the code of subject software, identify the functional aspects of the code, and identify the corresponding formal components of those functional aspects. During conventional unit testing procedures, a developer, tester, or other personnel may have to manually examine the code of the subject software and identify the functional aspects and their corresponding formal components. The system of the invention, however, automatically performs this step, which improves reliability, conserves personnel resources, and otherwise improves unit testing.

For example, in one embodiment, the parsing module may analyze the code of the subject software and may utilize predefined heuristics, rules, and/or a priori knowledge of how the programming language of the subject software is translated to functional results. This analysis enables the parsing module to automatically identify the functional aspects and corresponding formal components of the subject software.

In one embodiment, the subject software may be programmed in an object-oriented programming language. In these embodiments, the formal components identified by the parsing module may include classes, functions, methods, or other formal components that enable the functional aspects of an object-oriented subject software.

In some embodiments, the subject software may comprise object code. In these embodiments, the reflection API may be used to identify the functional aspects and/or formal components of the subject software.

In one embodiment, in addition to identifying the formal components utilized by the functional aspects of the subject software, the parsing module may also identify the parameter types that are utilized by the functional aspects of the subject software. The parsing module may identify these parameter types by examining the identified formal components (e.g., classes, functions, methods or other formal components) of the subject software to determine what types of parameters are taken as input and provided as output by the subject software.

The system of the invention may also include a unit testing module. The unit testing module may include a software module or other computer readable instructions that enable the automated generation of test parameters for the subject software, the creation of test cases, the automatic generation of test code for unit testing the subject software, the automated unit testing of the subject software, and/or other features.

In one embodiment, the unit testing module may generate test parameters for testing the identified functional aspects of the subject software. In one embodiment, the unit testing module may examine and utilize the formal components and parameter types identified for each of the functional aspects of the subject software. For example, if the identified formal components include classes, functions, methods, or other components of object oriented code, the unit testing module may determine a set of test parameters for these classes, functions, methods, or other components, based on the identified parameter types for these formal components. In one embodiment, the generated test parameters may be used to test the proper operation of the functional aspects of the subject software in a reasonable set of possible circumstances.

In one embodiment, the unit testing module may store the generated test parameters and the identified formal components for one or more identified functional aspects as a “test case” for the one or more functional aspects.

In one embodiment, the system of the invention includes a test case document generator. In one embodiment, the test case document generator includes a software module or other set of computer readable instructions that generates a computer readable document (e.g., an XML document) for each test case. In one embodiment the document generated for each test case may include some or all of the identified formal components and generated test parameters for the corresponding functional aspects of the test case. The document may be utilized to test the functional aspects of the subject software.

In one embodiment, the unit test module may generate test code for unit testing each of the stored test cases. The test code may comprise software code that executes the functional aspects of the subject software using the generated test parameters. The unit test module may utilize the identified formal components and the generated test parameters for each functional aspect of a test case to generate the test code for the test case. In one embodiment, the document generated by the test case document generator may be used to generate the test code and/or execute the unit tests for each test case. If, for example, the document is an XML document, the unit test module may utilize an XML parser and serializer to parse the document and generate the test code.

In one embodiment, the test code is software code written in a specific software language that, when executed, executes the functions of the software to be tested. The test code executes these functions using the generated test parameters to determine whether the functions perform properly.

In one embodiment, the unit testing module may perform unit testing. In one embodiment, the unit testing may be performed by executing the test code for each test case. Executing the test code essentially executes the identified functional aspects of the subject software using the test parameters. In one embodiment, the original code of the subject software that is responsible for the tested functional aspects may be incorporated into the test code and executed by the test code. In another embodiment, the executed test code may operate indirectly, calling the portions of the original code of the subject software that are responsible for the tested function.

Upon execution of the test code, a pass or fail result will be generated for each identified functional aspect of the subject software. For example, if a particular functional aspect performed properly under all of the generated parameters, then that functional aspect receives a “pass” rating. If the functional aspect did not perform properly under some or all of the generated test parameters, then it receives a “fail” rating.

In one embodiment, the individual formal components of a functional aspect of the subject software (e.g., the functions or methods that comprise each functional aspect) may each receive their own pass/fail rating that are used to determine the pass/fail rating of the functional aspect. For example, if a functional aspect of the subject software included multiple functions or methods, and one or more of the functions or methods received fail ratings, then the functional aspect of the software may receive a fail rating. If all of the functions or methods received pass ratings, then the functional aspect of the software would receive a pass rating.

If each test case includes only one functional aspect, then the pass/fail rating of the functional aspect is the pass/fail rating of the test case. However, if a test case includes one or more functional aspects of the subject software, then a closer examination of the pass/fail ratings of the functional aspects is necessary to determine the pass/fail rating of the test case. For example, if one or more of the functional aspects of the test case receives a fail rating, then the test case may receive a fail rating. If all of the functional aspects of a test case receive a pass rating, the test case may receive a pass rating.

In one embodiment, the unit testing application includes a reporting module. In one embodiment, the reporting module may generate and send one or more reports regarding the results of unit testing to one or more destinations, including, for example, one or more users, one or more computer or computer networks, one or more printers, or other destinations. In some embodiments, the reports generated by reporting module may include details of the identified functional aspects of the subject software, the identified formal components of the subject software, the generated test parameters, the test case breakdowns, the pass/fail results, and/or other information. In one embodiment, the reports generated by the reporting module may be sent via email, may be sent to a printer, or may otherwise be provided to a user or computer system.

These and other objects, features, and advantages of the invention will be apparent through the detailed description of the preferred embodiments and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of a system for automated unit testing, according to one embodiment of the invention.

FIG. 2 illustrates an example of a process for automated unit testing according to an embodiment of the invention.

### DETAILED DESCRIPTION

The invention provides a system and method for automated unit testing of software. In one embodiment, the invention provides for discovery of the functional aspects of a piece of software code. The invention then generates a set of testing parameters designed to test the piece of software code for proper operation of each of the discovered functions. The discovered functions and their corresponding testing parameters may then be stored as one or more test cases. Test code is then generated for each test case. The test code enables each test case to be run to determine whether the corresponding functions operate properly.

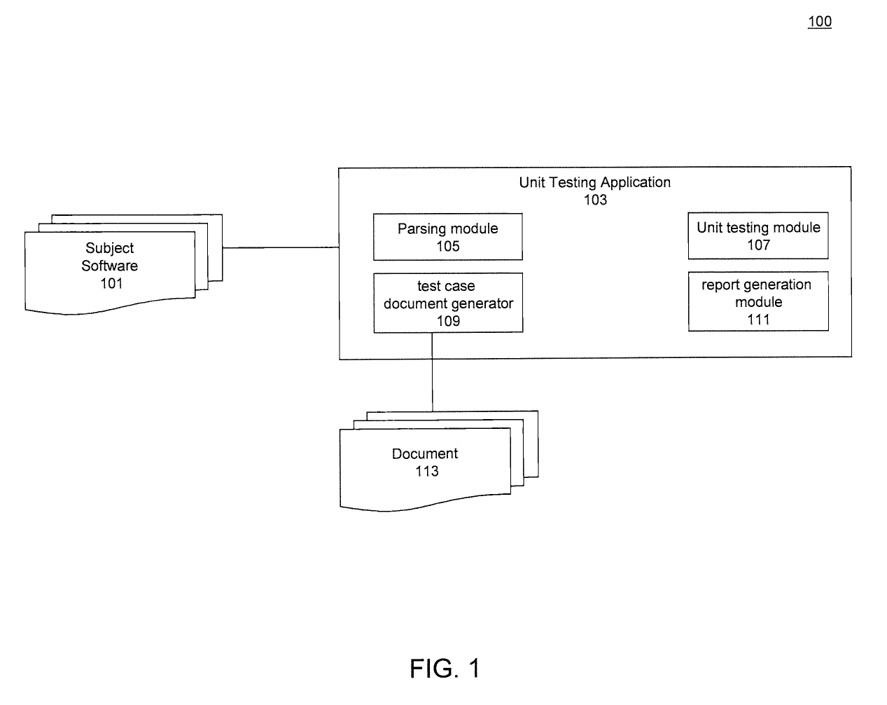

In one embodiment, the invention provides a system for automated unit testing of software. FIG. 1 illustrates an example of a system 100 for automated unit testing, according to one embodiment of the invention. In one embodiment, system 100 may include an automated unit testing application 103 and or other elements. System 100 may interact with subject software 101, may produce test case document 113, and/or may include other interaction or output.

In one embodiment, subject software 101 may comprise a portion of software code to be tested. Subject software 101 may comprise source code written in one of any number of available programming languages. In one embodiment, subject software 101 may be written in an object-oriented programming language such as, for example, Java. Other programming languages may be used. In some embodiments, subject software 101 may comprise object code (e.g., machine-readable code) and may take the form of, for example, an executable file.

In one embodiment, subject software 101 may include one or more “functional aspects.” These functional aspects may comprise the general functional purposes that subject software 101 serves. For example, if subject software 101 is designed to print customer lists retrieved from a database, subject software 101 may include three functional aspects: 1) retrieval of data from the database, 2) formatting the data for printing, and 3) sending the formatted data to a printer. Other software may have other functional aspects. In some embodiments, some of these functional aspects may have “cross-cutting concerns.” For example, even if the subject software is coded using an object-oriented programming language, the subject software may include one or more functional aspects (like logging/security, etc.) that affect other functional aspects.

In some embodiments, each of these functional aspects may be implemented in subject software 101 by one or more formal components of the software language in which subject software 101 is written. For example, if subject software 101 is coded using an object-oriented programming language, subject software 101 may include one or more classes, functions, methods, or other elements that are used to carry out each of its functional aspects.

In one embodiment, system 100 includes a unit testing application 103, which may comprise a computer application that is designed to automate the unit testing of subject software 101 and/or other software code. Unit testing application 103 may comprise and/or utilize one or more software modules for performing automated unit testing. In one embodiment, the one or more software modules may include a parsing module 105, a unit testing module 107, a test case document generator 109, a report generation module 111, and/or other modules.

In one embodiment, parsing module 105 may include a software module or other computer readable instructions that examine the code of subject software 101, identify the functional aspects of the code, and identify the corresponding formal components of those functional aspects. During conventional unit testing procedures, a developer, tester, or other personnel may have to manually examine the code of subject software 101 and identify the functional aspects and their corresponding formal components. The system of the invention, however, automatically performs this step, which improves reliability, conserves personnel resources, and otherwise improves unit testing.

For example, in one embodiment, parsing module 105 may analyze the code of subject software 101 and may utilize predefined heuristics, rules, and/or a priori knowledge of how the programming language of subject software 101 is translated to functional results. This analysis enables parsing module 105 to automatically identify the functional aspects and corresponding formal components of subject software 101.

In one embodiment, the parsing module 105 may be able to identify the functional aspects and formal components of subject software 101 regardless of what programming language subject software is written in. In some embodiments, this “language independence” may be enabled by the predefined heuristics, rules, and/or a priori knowledge utilized by parsing module 105. This knowledge may include information (e.g., look up tables, etc.) that may enable parsing module 105 to identify functional aspects and formal components in some or all commonly used programming languages. In some embodiments, parsing module 105 may utilize coding conversions best practices, code annotations, or other characteristics that are common across all programming languages.

In some embodiments, parsing module 105 may not include the a priori knowledge necessary to parse the code of a particular piece of subject software 101 (e.g., parsing module 105 may not be able to recognize the functional aspects and formal components of the particular language in which subject software 101 is written). However, in these cases, a user (e.g., a developer, a tester, or other user) may provide such information, enabling parsing module 105 to continue.

In one embodiment, subject software 101 may be programmed in an object-oriented programming language. In these embodiments, the formal components identified by parsing module 105 may include classes, functions, methods, or other formal components that enable the functional aspects of an object-oriented subject software 101.

In some embodiments, subject software 101 may comprise object code. In these embodiments, the reflection API, which is an application programming interface that represents or reflects classes, interfaces, and objects in object code, may be used, along with best practices, by parsing module 105 to identify the functional aspects and formal components of subject software 101. The reflection API is traditionally used for self-optimization or self-modification of a program for dynamic system adaptation. In this case, however, the invention uses the reflection API for code generation and parameter generation. The reflection API is used when subject software is object code. In the case of source code, code annotations, source code parsers, dynamic proxy generators, coding conventions, and best practices are used with parsing module 105.

In one embodiment, in addition to identifying the formal components utilized by the functional aspects of subject software 101, parsing module 105 may also identify the parameter types that are utilized by the functional aspects of subject software 101. Parsing module 105 may identify these parameter types by examining the identified formal components (e.g., classes, functions, methods or other formal components) of subject software 101 to determine what types of parameters are taken as input and provided as output by subject software 101.

System 100 may also include a unit testing module 107. Unit testing module 107 may include a software module or other computer readable instructions that enable the automated generation of test parameters for subject software 101, the creation of test cases, the automatic generation of test code for unit testing subject software 101, the automated unit testing of subject software 101, and/or other features.

In one embodiment, unit testing module 107 may generate test parameters for testing the identified functional aspects of subject software 101. In one embodiment, unit testing module 107 may examine and utilize the formal components and parameter types identified for each of the functional aspects of subject software 101. For example, if the identified formal components include classes, functions, methods, or other components of object oriented code, unit testing module 107 may determine a set of test parameters for these classes, functions, methods, or other components, based on the identified parameter types for these formal components. In one embodiment, the generated test parameters may be used to test the proper operation of the functional aspects of subject software 101 in a reasonable set of possible circumstances.

In one embodiment, unit testing module 107 may store the generated test parameters and the identified formal components for one or more identified functional aspects as a “test case” for the one or more functional aspects. In some embodiments, a test case may refer to the identified formal components and generated test parameters for a single identified functional aspect of subject software 201 (e.g., the number of identified functional aspects for subject software equals the number of test cases). In other embodiments, a single test case may include the identified formal components and generated test parameters for more than one functional aspect of subject software 101.

In one embodiment, system 100 includes a test case document generator 109. In one embodiment, test case document generator 109 includes a software module or other set of computer readable instructions that generates a computer readable document 113 for each test case. In one embodiment document 113 generated for each test case may include some or all of the identified formal components and generated test parameters for the corresponding functional aspects of the test case. Document 113 may be utilized to test the functional aspects of subject software 101. In one embodiment, document 113 may comprise an XML document. Other formats may be used. The following is an example of the schema of an XML document for a test case:

```
<TestSuite>
  <Module Name=“given executable name”>
    <Class Name=“Class Name” ConstructorCount =“No. of
    constructors”
DefaultConstructor =
            “True/False”>
        <Function Name=“Function name” Static=“True/False”
ReturnType=“Return type”>
          <ParameterSet Type=“Test case type (Positive/Negative)”
  Count=“Parameter Count”>
            <Parameters>
            <Parameter Name=“Prameter name” Type=“Parameter
                type” IsSerializable=“True/False”>
              </Parameter>
            ........
            ........
            </Parameters>
          </ParameterSet>
          .......
          .......
          </Function>
          ........
          ........
      </Class>
      .........
      .........
  </Module>
</TestSuite>
```

In one embodiment, unit test module 107 may generate test code for unit testing each of the stored test cases. The test code may comprise software code that executes the functional aspects of subject software 101 using the generated test parameters. Unit test module 107 may utilize the identified formal components and the generated test parameters for each functional aspect of a test case to generate the test code for the test case. In one embodiment, document 113 generated by test case document generator 109 may be used to generate the test code and/or execute the unit tests for each test case. If, for example, document 113 is an XML document, unit test module 107 may utilize an XML parser and serializer to parse document 113 and generate the test code.

In one embodiment, the test code is software code written in a specific software language that, when executed, executes the functions of the software to be tested. The test code executes these functions using the generated test parameters to determine whether the functions perform properly.

In one embodiment, unit testing module 107 may perform unit testing. In one embodiment, the unit testing may be performed by executing the test code for each test case. Executing the test code essentially executes the identified functional aspects of subject software 101 using the test parameters. In one embodiment, the original code of subject software 101 that is responsible for the tested functional aspects may be incorporated into the test code and executed by the test code. In another embodiment, the executed test code may call the portions of the original code of subject software 101 that are responsible for the tested function.

Upon execution of the test code, a pass or fail result will be generated for each identified functional aspect of subject software 101. For example, if a particular functional aspect performed properly under all of the generated parameters, then that functional aspect receives a “pass” rating. If the functional aspect did not perform properly under some or all of the generated test parameters, then it receives a “fail” rating.

In one embodiment, the individual formal components of a functional aspect of subject software 101 (e.g., the functions or methods that comprise each functional aspect) may each receive their own pass/fail rating that are used to determine the pass/fail rating of the functional aspect. For example, if a functional aspect of subject software 101 included multiple functions or methods, and one or more of the functions or methods received fail ratings, then the functional aspect of the software may receive a fail rating. If all of the functions or methods received pass ratings, then the functional aspect of the software would receive a pass rating.

If each test case includes only one functional aspect of subject software 101, then the pass/fail rating of the functional aspect is the pass/fail rating of the test case. However, if a test case includes one or more functional aspects of subject software 101, then a closer examination of the pass/fail ratings of the functional aspects is necessary to determine the pass/fail rating of the test case. For example, if one or more of the functional aspects of the test case receives a fail rating, then the test case may receive a fail rating. If all of the functional aspects of a test case receive a pass rating, the test case may receive a pass rating.

In one embodiment, unit testing application 103 includes a reporting module 111. In one embodiment, reporting module 111 may generate and send one or more reports regarding the results of unit testing to one or more destinations, including, for example, one or more users, one or more computer or computer networks, one or more printers, or other destinations. In some embodiments, the reports generated by reporting module may include details of the identified functional aspects of subject software 101, the identified formal components of subject software 101, the generated test parameters, the test case breakdowns, the pass/fail results, and/or other information. In one embodiment, the reports generated by reporting module 111 may be sent via email, may be sent to a printer, or may otherwise be provided to a user or computer system.

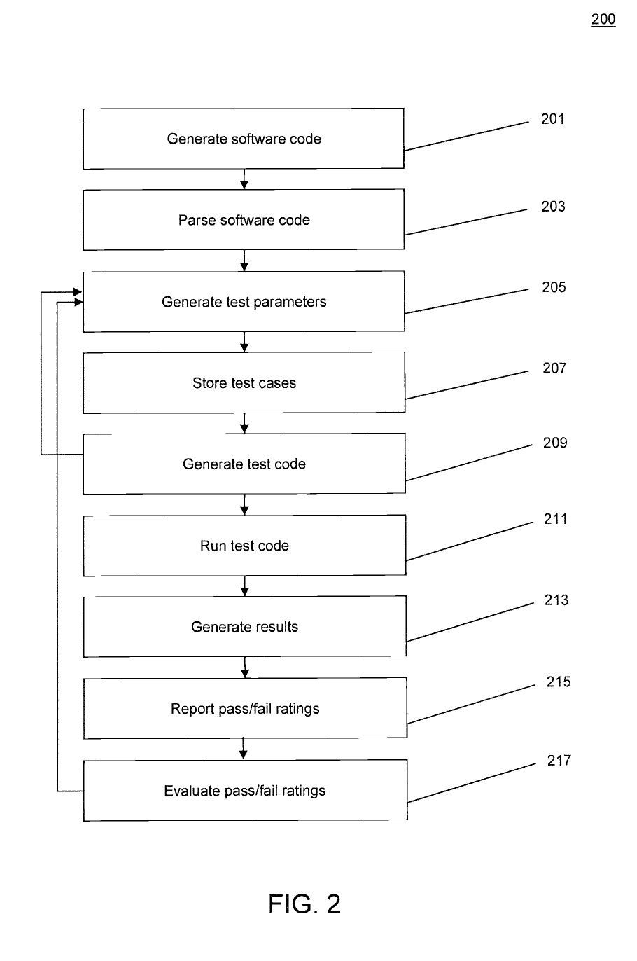

FIG. 2 illustrates process 200, wherein automated unit testing of subject software 101 may be performed, according to an embodiment of the invention. Process 200 may include an operation 201, wherein the portion of software code may be generated. In one embodiment subject software 101 comprises an executable file.

In some embodiments, subject software 101 may be generated manually (e.g., it may be written by a software developer). In some embodiments, subject software 101 may be automatically generated such as, for example, by a software development application. In some embodiments, subject software 101 may be generated by a combination of manual and automated methods.

In some embodiments, subject software 101 may comprise source code, or code that must be compiled into object code prior to being run on a machine. In other embodiments, subject software may comprise object code (i.e., machine-readable code).

In an operation 203, subject software 101 may be parsed or otherwise scrutinized to identify the functional aspects of its code, the parameter types that are utilized by these functional aspects, and/or other information. This parsing/scrutiny may also identify the formal structure of the code that implements these functional aspects. For example, if the software code were source code created in an object-oriented language, this parsing may identify the classes within the code, the functions or methods of the classes, the parameter types used by the functions or methods, or other information.

In one embodiment, each functional aspect of the software code may include a set of one or more parameter types that are utilized to perform their respective functions. Each of these functions may be considered the basis for individual test cases. In an operation 205, the specific testing parameters for each of the identified functions of the software code may be generated. These testing parameters may include the values, variables, data, and/or other test vectors necessary to test whether a particular function of the software code operates properly. These testing parameters may attempt to ensure this proper function in a high percentage of possible scenarios. However, in some instances it may be impossible to ensure this proper function in 100% of possible scenarios.

In some embodiments, the testing parameters may be automatically generated by a software module such as, for example, unit testing module 107. Other software modules or combinations thereof may be used. Unit testing module 107 may utilize the functional, formal, structural, or other information identified in operation 203 to generate test parameters.

In an operation 207, the identified functional, formal, or structural information and/or the generated test parameters may be stored as “test cases.” That is, for each functional aspect of the software code, the corresponding formal/structural information and generated testing parameters may be stored as a single “test case.” In some embodiments, storing the test cases may include generating a document 113 for each test case. In some embodiments, the documents 113 for each test case includes details regarding the identified classes, functions, parameter types, and the generated parameters for testing each function. In one embodiment, the test case document generator 109 generates test case documents 113.

In an operation 209, test code may be generated for each test case. The test code is generated using the identified functional, structural, and/or formal data and the generated testing parameters. In some embodiments, the test code for each test case is generated using the documents 113 for each test case. The test code is software code written in a specific software language that, when executed, executes the functions of the software to be tested. The test code executes these functions using the generated test parameters to determine whether the functions perform properly. In one embodiment, unit testing module 107 generates the test code in operation 209. Other methods or modules may be used.

In an operation 211, the test code for each test case may be run. Running the test code essentially executes the identified functions of the software code to be tested. This may be done by incorporating the original code (from subject software 101) responsible for the functions into the test code and executing the test code. It may also be done by having the test code call the portions of the original code (from subject software 101) responsible for the tested function. In one embodiment, unit testing module 107 may run the test code. In other embodiments other modules or methods may be used.

In an operation 213, the results of the tests may be produced. For each identified function of the subject software 101, a pass or fail result will be generated. For example, if a particular function performed properly under all of the generated parameters, then that function receives a “pass” rating. If the function did not perform properly under some or all of the generated test parameters, then it receives a “fail” rating.

If one or more functions or methods are used to perform a greater “functional aspect” of the tested code, then the each of the pass/fail ratings for those functions or methods may be used to determine a pass/fail rating for the functional aspect of subject software 101. For example, if a functional aspect of the software included multiple functions or methods, and one or more of the functions or methods received fail ratings, then the functional aspect of the software would receive a fail rating. If all of the functions or methods received pass ratings, then the functional aspect of the software would receive a pass rating. Depending on how a “test case” is defined, the pass/fail ratings for the greater functional aspect of the software may translate directly to a pass/fail rating for a test case.

In an operation 215, the pass/fail ratings for some or all of the functions, methods, greater functional aspects, and/or test cases may be reported to one or more users. In one embodiment, reporting of pass/fail ratings may include displaying the pass/fail ratings to a user via a graphical under interface (e.g., on a computer screen). In other embodiments, reporting of pass/fail ratings may include generating a document that details the pass/fail ratings of the test cases and or their constituent functional aspects, functions or methods. This document may be printed, emailed or otherwise communicated to one or more users.

In an operation 217, the reported pass fail ratings may be analyzed and the software code may either be deemed acceptable or unacceptable. If it is deemed unacceptable, subject software 101 may be re-written, altered and/or subject to additional testing. If the software code is deemed acceptable, the software development process may proceed (e.g., further testing, implementation, further code development, or other operations may be performed).

Those having skill in the art will appreciate that the invention described herein may work with various configurations. Accordingly, more or less of the aforementioned system components may be used and/or combined in various embodiments. Additionally, more or less of the aforementioned operations may be performed and/or various operation may be performed in varying order. It should also be understood that the various software modules discussed herein and unit testing application 103 that are utilized to accomplish the functionalities described herein may be maintained and or executed on one or more special purpose or general purpose computers and/or processors cable of responding to and executing instructions in a defined manner as necessary. In some embodiments, as would be appreciated, the functionalities described herein may be implemented in various combinations of hardware and/or firmware, in addition to, or instead of, software.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A method for automated unit testing of an executable created using an object-oriented language, the method comprising:
identifying one or more classes, functions, and parameter types of the executable;
generating one or more parameters for the functions;
storing the one or more identified classes, functions, and parameter types and the one or more generated parameters as one or more unit test cases; and
performing one or more unit tests using the one or more unit test cases by executing each of the identified functions using the one or more generated parameters.

2. The method of claim 1, wherein a software module automatically identifies the one or more classes, functions, and parameter types of the executable.

3. The method of claim 2, wherein the software module is a reflection API.

4. The method of claim 2, wherein the software module includes one or more of code annotations, source code parsers, and dynamic proxy generators.

5. The method of claim 1, wherein the one or more parameters are generated automatically.

6. The method of claim 1, wherein the one or more unit tests are performed automatically.

7. The method of claim 1, wherein storing the one or more identified classes, functions, and parameter types and the one or more generated parameters as one or more unit test cases further comprises generating a document that includes the one or more identified classes, functions, parameter types, and parameters.

8. The method of claim 7, wherein the document comprises an XML document.

9. The method of claim 1, wherein storing the one or more identified classes, functions, and parameter types and the one or more generated parameters as one or more unit test cases further comprises generating test code that, when executed executes each of the identified functions using the one or more parameters and wherein performing one or more unit tests further comprises executing the test code.

10. The method of claim 1, further comprising generating at least one report regarding the results of the one or more unit tests.

11. The method of claim 7, wherein the at least one report includes pass/fail information regarding at least one of the one or more unit tests.

12. The method of claim 8, wherein pass/fail information regarding at least one of the one or more unit tests further includes information regarding one or more of the identified functions.

13. A system for automated unit testing of an executable created using an object-oriented language, the system comprising:
a universal identification module that parses the code of the executable and automatically identifies one or more of the classes, functions, and parameter types of the executable; and
a unit testing module that automatically generates one or more parameters for each of the functions and stores the one or more identified classes, functions, and parameter types and the one or more generated parameters as one or more unit test cases, wherein the unit test module also automatically performs one or more unit tests using the one or more unit test cases by executing each of the identified functions using the one or more generated parameters.

14. The system of claim 13, wherein the universal identification module utilizes a reflection API.

15. The system of claim 13, wherein the universal identification module utilizes one or more of code annotations, source code parsers, and dynamic proxy generators.

16. The system of claim 13, wherein the unit testing module stores the one or more identified classes, functions, and parameter types and the one or more generated parameters as a document that details the one or more identified classes, functions, and parameter types and the one or more generated parameters.

17. The system of claim 16, wherein the document comprises an XML document.

18. The system of claim 13, wherein the unit testing module generates test code for performing the one or more unit tests.

19. The system of claim 13, wherein the unit testing module generates at least one report regarding the results of the one or more unit tests.

20. The system of claim 19 wherein the at least one report includes pass/fail information regarding at least one of the one or more unit tests.

21. The system of claim 20, wherein pass/fail information regarding at least one of the one or more unit tests further includes information regarding one or more of the functions.

22. A method for automated unit testing of an executable created using an object-oriented language, the method comprising:
generating the executable;
automatically identifying one or more classes, functions, and parameter types of the executable;
generating one or more parameters for the functions;
storing the one or more identified classes, functions, and parameter types and the one or more generated parameters as a document of one or more unit test cases;
generating unit test code for at least one of the one or more unit test cases using the document, wherein, for each unit test case, the unit test code executes the one or more identified function for that unit test case using the one or more generated parameters; and
automatically performing one or more unit tests using the one or more unit test cases by executing the unit test code.
